(19) United States
(12) Patent Application Publication
(10) Pub. No.: US 2012/0090435 A1
(43) Pub. Date: Apr. 19, 2012

(54) SCREW AND SCREWDRIVER FOR SCREWING AND UNSCREWING THE SCREW

(76) Inventor: NURLAN DAULETBAYEV, Kokshetau (KZ)

(21) Appl. No.: 12/993,626

(22) Filed: Nov. 19, 2010

(30) Foreign Application Priority Data
May 19, 2008 (KZ) PCT/KZ2009/000005

(51) Int. Cl. B25B 15/02; F16B 23/00

(52) U.S. Cl. 81/436; 411/406

(57) ABSTRACT

The invention relates to hand tools and to threaded fasteners, and comprises a screw and corresponding screwdriver. The screw comprises a head and a threaded working end. The head slot for inserting the screwdriver is made in the form of a “dove tail.” The working section of the screwdriver for screwing and unscrewing the screw is made as a mirror image of the screw head slot, with the same angle of slope. The invention lengthens the life of screwdrivers and screws and their serviceability.

### CROSS-REFERENCE TO RELATED APPLICATION

This application claims the benefit of the priority filing date in PCT/KZ2009/000005, as amended and referenced in WIPO Publication WO2009/142469. The earliest priority date claimed is May 19, 2008.

### FEDERALLY SPONSORED RESEARCH

None

### SEQUENCE LISTING OR PROGRAM

None

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention relates to hand tools and screws, and can be used in households, and in the agriculture, furniture, and construction industries, i.e., anywhere where screws and screwdrivers are used.

Widely known are screws with slots and screwdriver working ends that are tapered, including cross-recessed slots and working ends.

The use of such screws requires applying considerable force for screwing and unscrewing because the screw slot angle is more than 90°. Moreover, the screw-screwdriver engagement is unreliable, and the resulting repulsive force causes deformation of the screw and screwdriver contact surfaces leading to distortion of the screw slot faces and the screwdriver working end. The objective of the invention is to develop a “screw-screwdriver” pair that ensures fast and reliable operation when assembling and disassembling devices using screws, and thereby to increase the number of times screws can be used.

The anticipated technical result is to increase the life of screws while allowing for fast and high-quality assembly and disassembly of devices where screws are used.

The technical result is achieved by a dove tail type slot made in the screw, with a slope angle that is opposite the direction of the traditional embodiment. In this way, and unlike with the traditional screw and screwdriver, a latch-type contact is formed in the screwdriver-screw pair. Also, additional attractive forces form between the screw and screwdriver, as opposed to repulsive forces in the case of the traditional embodiment of the screw slot and the screwdriver working end.

### SUMMARY

The invention relates to hand tools and to threaded fasteners, and can be used in households, as well as the agriculture, furniture, and construction industries, i.e., anywhere where screws and screwdrivers are used. The invention is a screw and corresponding screwdriver. The screw comprises a head and a threaded working end. The head slot for inserting a screwdriver is made in the form of a “dove tail.” The working section of the screwdriver for screwing and unscrewing the screw is made as a mirror image of the screw head slot, with the same angle of slope. The invention lengthens the life of screwdrivers and screws and their serviceability.

### DRAWINGS

The essence of the invention is explained in the drawings where FIG. 1 shows the proposed screw design, and

FIG. 2 shows the working end of the screwdriver for the screw.

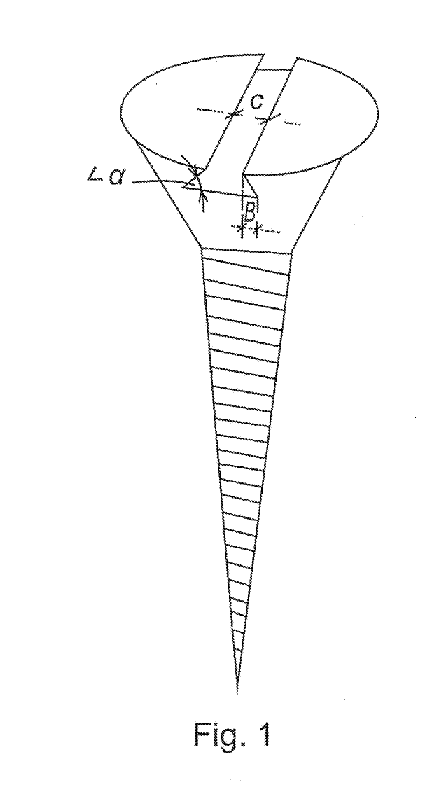

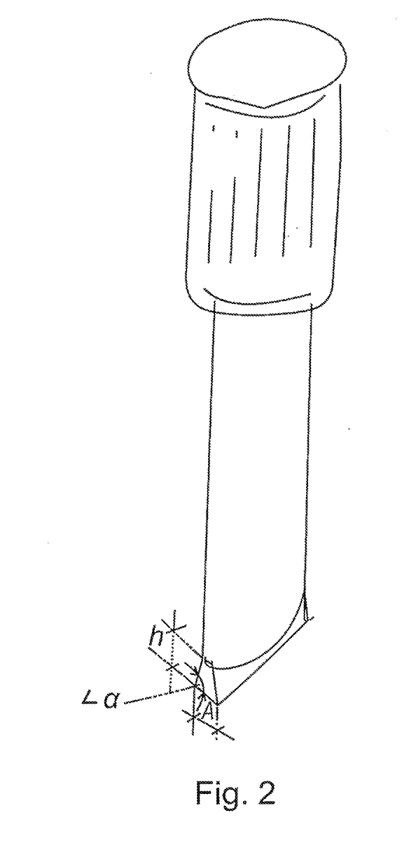

### DESCRIPTION

The screw head has a 0.5-2.0 mm deep slot (the slot depth depends on the size of the screw), and the slope angle of the slot face α<85°.

The screwdriver working end is a mirror image of the screw head slot. The width of the screwdriver's lower working end is slightly smaller—by 0.5-1.0 mm —compared to the width of the respective upper section of the slot on the screw surface. The slope angle a of the side surface of the screwdriver working end, as well as the slope angle of the screw slot face, is also α<85°, equal to the slope angle of the screw slot face. Because of the smaller size of the screwdriver working end, it is possible to insert the screwdriver into the screw slot from the top.

Such screw-screwdriver pair is reliable in operation. There are no distortions, and one does not have to apply considerable force to prevent the screwdriver from disengaging from the screw because a pair operation of a latch-type joint is formed.

The use of the proposed screw-screwdriver pair will make it possible to significantly improve the reliability of assembly, speed up disassembly, increase productivity, and reduce occupational hazards.

The following are claimed:

1. A screw comprising a head and a threaded working end, distinctive in that the screw head slot for inserting a screwdriver is made in the form of a 0.5-2.0 mm high dove tail wherein the angle of slope of the slot face with respect to the screw head surface α<85°.

2. The screwdriver for screwing and unscrewing the screw per claim 1, distinctive in that the screwdriver working end is made as a mirror image of the screw head slot, with the same angle of slope, wherein the dimensions of the working end are 0.5-1.0 mm smaller than the dimensions of the screw head slot.
